(19) United States
(12) Patent Application Publication
(10) Pub. No.: US 2009/0161704 A1
(43) Pub. Date: Jun. 25, 2009

(54) INTRACAVITY UPCONVERSION LASER

(75) Inventors: Ulrich Weichmann, Aachen (DE); Gero Heusler, Aachen (DE); Holger Mönch, Vaals (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,690

(22) PCT Filed: Apr. 17, 2007
(86) PCT No.: PCT/IB2007/051367

§ 371 Date: Oct. 10, 2008

(30) Foreign Application Priority Data
Apr. 27, 2006 (EP) 06113175.1

(51) Int. Cl. H01S 3/10

(52) U.S. Cl. 372/22

(57) ABSTRACT

The present invention relates to an upconversion laser system comprising at least a semiconductor laser having a gain structure (4) arranged between a first mirror (5) and a second mirror (6), said first (5) and said second mirror (6) forming a laser cavity (7) of the semiconductor laser, and an upconversion laser for upconverting a fundamental radiation of said semiconductor laser. The upconversion laser system of the present invention is characterized in that the upconversion laser is arranged in the laser cavity (7) of the semiconductor laser. The proposed upconversion laser system has a compact design.

The present invention relates to an upconversion laser system comprising at least a semiconductor laser having a gain structure arranged between a first mirror and a second mirror, said first and said second mirror forming a laser cavity of the semiconductor laser.

Highly efficient semiconductor laser typically emit fundamental radiation in the infrared (IR) wavelength range. Many applications however require optical radiation in the visible or ultraviolet wavelength range. In order to use IR semiconductor lasers for such applications it is known to couple the output of the semiconductor laser into the gain medium of an upconversion laser, typically a special waveguide or fiber laser, which generates the desired laser wavelength in the visible wavelength range.

In the upconversion process, a high-lying electronic state of an atom is populated by the absorption of two or more pump photons via intermediate resonances. From this high-lying electronic state a photon of higher energy and accordingly shorter wavelength than the pump radiation is emitted. Using this upconversion process it is possible to convert infrared laser radiation to radiation in the visible wavelength range. A prominent example is the upconversion laser based on Er-doped ZBLAN-glass, where two photons of 970 nm wavelength are absorbed by Er³⁺-ions and radiation around 550 nm is emitted. Currently, there is an increased interest in this process, since it provides the opportunity to realize an integrated green laser source.

However, due to the required absorption of two photons for the upconversion process, high pump power densities have to be provided. Today this is achieved by confining the pump light to a waveguide, as in the case of the upconversion fiber laser. In this laser the pump radiation from e.g. a laser diode is focused into the Er-doped core of a glass-fiber. The fiber facets are coated with dielectric coatings that transmit the pump radiation and have a certain reflectivity for the upconversion laser radiation, so that a resonator is formed. Typically, the core of these fibers has diameters in the range 2-40 μm. Such small diameters make the coupling of the pump radiation a difficult task. Coupling losses of the pump radiation to the fiber limit the efficiency of the upconversion laser and lead to relatively high laser thresholds.

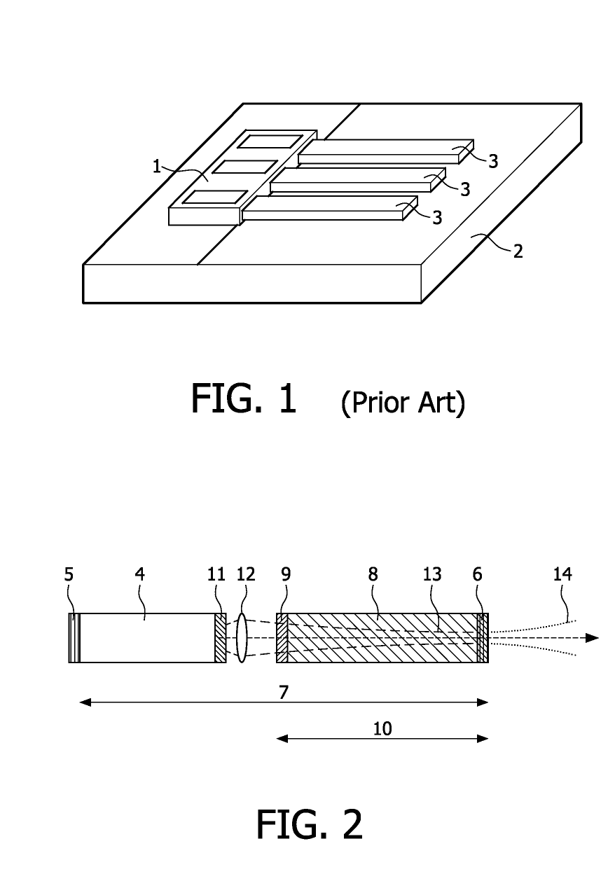

An example of an upconversion laser system improving the coupling efficiency is disclosed in WO 2005/022708 A1 and shown in FIG. 1. Several semiconductor lasers are provided as a laser diode bar 1 on a Cu cooling plate 2. The output of each laser diode is coupled into a waveguide laser 3 consisting of the upconverting material. The dimensions of the waveguide lasers 3 are adapted to the dimensions of the laser diodes, i.e. they are in the range of a few micrometers. Nevertheless the coupling of the pump radiation from the laser diodes to the waveguide lasers 3 is difficult and leads to significant coupling losses. Due to these coupling losses and the overall design of such an upconversion laser system, the length of the waveguide or fiber comprising the upconverting material is in the range of typical 50 cm in order to achieve the desired power of the upconverted radiation.

It is an object of the present invention, to provide an upconversion laser system having compact dimensions at the same or even higher output power than the above described upconversion laser system.

The object is achieved with the upconversion laser system according to claim 1. Advantageous embodiments of this laser system are subject matter of the dependent claims or described in the following description and embodiments.

The proposed upconversion laser system comprises at least a semiconductor laser having a gain structure arranged between a first mirror and a second mirror, said first and said second mirror forming a laser cavity of the semiconductor laser, and an upconversion laser for upconverting a fundamental radiation of said semiconductor laser. The upconversion laser system of the present invention is characterized in that said upconversion laser is arranged in the laser cavity of the semiconductor laser, which serves as pump laser for the upconversion laser.

This means that the upconverting material is placed inside the pump laser cavity. Inside the pump laser cavity the pump power density is highest and losses to this cavity are ideally only given by the absorption in the upconverting material. Furthermore, the pump radiation is absorbed in multiple passes through the upconverting material, so that the single pass absorption of this material can be kept much lower than for example with a fiber laser. Therefore the length of the upconverting material can be in the order of a few millimeters. This is a drastic size reduction even without any changes in the doping concentration of the upconverting material. Therefore, the proposed upconversion laser system can be designed in very compact dimensions.

No waveguide or fiber is needed in this intracavity pumping scheme for the upconversion laser. The gain region of the upconversion laser is defined by the pump beam. This makes the alignment of such an upconversion laser an easy task and coupling losses are reduced to a minimum.

The upconverting material is pumped much more homogenously when placed inside the cavity of the pump laser. In fiber lasers, the first part of the fiber is always pumped much stronger than the last, due to absorption of the pump radiation in the fiber. Since in the present upconversion laser system the interaction length is drastically reduced, as explained above, the pump absorption along the upconverting material is much more homogeneous than in fiber lasers.

The compact size at relative high output power makes the proposed upconversion laser a good candidate to replace nowadays UHP lamps as the light source for projection systems or to serve as light source in fiber optic illumination units, for example in endoscopes or display systems. The laser system allows easy power scaling and mass manufacturing. The upconverting material and one of the resonator mirrors of the semiconductor laser can be made in a single element. This element can be placed in front of a single stripe edge emitting laser as well as in front of a laser bar or even a laser diode stack. It can be placed in front of a single VECSEL (Vertical External Cavity Surface Emitting Laser) for a single upconversion laser system or in front of an array of VECSELs. Given the proper optical cavity layout, in all these cases, the only critical parameters are the angles under which the upconverting material with the mirror coated on it has to be positioned. This means simplicity for laser alignment.

In the proposed upconversion laser system the upconversion laser preferably comprises a solid state medium made of the upconverting material between two mirrors, one highly reflective (preferably T<1%) and the other one partially transmitting (preferably T=1-30%) for upconverted radiation. Nevertheless, even more than 30% transmission may be preferred for the partially transmitting mirror (up to 96% has been proven to work efficiently in fibers for PrYb, up to 70% for Er-ZBLAN). In the preferred embodiment, one of said mirrors of the upconversion laser is the second mirror of the semiconductor laser. This mirror is preferably in direct contact with the upconverting material and also allows for coupling out a portion of the upconverted radiation. In a preferred embodiment the two mirrors of the upconversion laser are formed of dielectric coatings that are directly applied to the surface of the upconverting material.

In a further preferred embodiment, which can also be combined with other embodiments of the proposed upconversion laser system, an optical system generating a beam waist of the fundamental radiation within the upconverting material is arranged inside the semiconductor laser cavity. This optical system can be a single lens or a more complicated arrangement of optical elements. Such an optical system has a twofold advantage. First, the end mirror of the pump laser cavity or resonator can be a flat mirror, which facilitates the laser alignment. Secondly and more important, the beam diameters decrease and therefore the pump power density increases inside the upconverting material, resulting in a further improved efficiency of the upconversion laser. With the beam waist of the pump laser placed at the resonator mirror (second mirror), an optimum situation in view of pump power density is achieved.

In the case of a pump laser having a gain material emitting fundamental radiation in the infrared wavelength range, for example at a central wavelength of 970 nm, the upconverting material of the upconversion laser is preferably an Er³⁺-doped ZBLAN-glass. Nevertheless, the present upconversion laser system is not restricted to the upconversion of infrared radiation or to the use of doped ZBLAN-glass as the upconverting material. The skilled person is able to use other combinations of gain materials for generating laser output of a desired wavelength. Such materials are for example other rare earth ions or a combination of ions in ZBLAN or other hosts like LiLuF₄, YLF, BaY₂F₈, Y₂O₃, YAlO₃ or tellurite glasses, all characterized by low phonon energies. Although in the following examples two special cavity layouts are described, there are also other possibilities for the cavity layout of the proposed upconversion laser system, which are generally known in the field of laser technique.

In the present description and claims the word “comprising” does not exclude other elements or steps as well as an “a” or “an” does not exclude a plurality. Also any reference signs in the claims shall not be construed as limiting the scope of these claims.

Exemplary embodiments of the proposed upconversion laser system are described in the following in connection with the accompanying figures without limiting the scope of the invention as defined by the patent claims. The figures show:

FIG. 1 an example of a known upconversion laser system;

FIG. 2 a schematic view of a first example of an upconversion laser system according to the present invention;

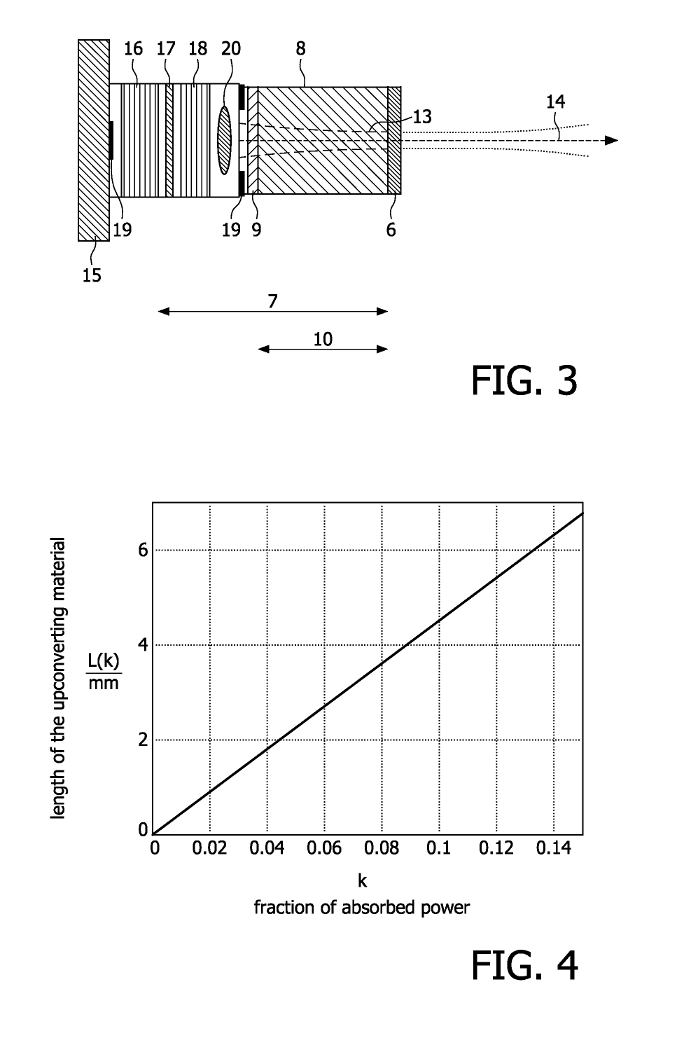

FIG. 3 a schematic view of a second example of an upconversion laser system according to the present invention; and

FIG. 4 a calculated function of the length of the upconverting material dependent on the fraction of absorbed pump power.

FIG. 2 shows a schematic view of an example of the proposed upconversion laser system of the present invention. An infrared diode laser is formed of a gain medium 4 placed between a first end mirror 5 and a second end mirror 6 which form a cavity of the diode laser, in the following also called pump laser cavity 7. The first mirror 5 is highly reflective for the fundamental IR radiation of the diode laser and is coated to an end face of the gain medium 4. The second mirror 6 is coated on an end face of an upconverting material 8, which is placed inside the cavity of the pump laser. This second mirror 6 is also highly reflective for the fundamental IR radiation and at the same time forms an outcoupling mirror of the upconversion laser, which is formed of the upconverting material 8 between the second mirror 6 and a third mirror 9. The second mirror 6 and the third mirror 9 at the ends of the upconverting material 8 establish the resonator for the upconversion laser, i.e. the upconversion laser cavity 10. The third mirror 9 is transparent for the fundamental IR radiation and highly reflective for the upconverted visible radiation. This third mirror 9 preferably also comprises an antireflective coating for the fundamental IR radiation. The second and third mirrors 6, 9 can be formed of dielectric coatings that are directly applied to the surface of the upconverting material 8. As is also shown in FIG. 2, the gain material 4 of the pump laser carries an antireflective or partially reflective coating 11 for IR radiation in order to minimize reflection losses of the fundamental IR radiation within the pump laser cavity 7.

In the pump laser cavity 7 a lens 12 is placed to achieve a beam waist 13 of the pump laser radiation within the upconverting material 8, for example 3000 ppm-doped Er:ZBLAN. The upconverted radiation is coupled out of this upconversion laser system through the second mirror 6 which is indicated as visible output 14 in FIG. 2.

The lens 12 reduces the beam diameter of the pump radiation within the upconverting material 8, leading to improved efficiency of the upconversion process. In FIG. 2 the resonator of the upconversion laser is sketched as an unstable resonator, with just two parallel surfaces at the opposite ends of the upconverting material 8. However, the optical cavity layout can be more complicated than the layout sketched in FIG. 2. For example, one end of the upconverting material 8 can form a spherically curved surface so that the resonator for the upconversion laser is stable. This has to be compensated for by the optics in the pump laser cavity, so that both lasers, the pump laser and the upconversion laser, use stable resonators with matched modes.

FIG. 3 is a schematic view of a further example of an upconversion laser system according to the present invention. In this example the laser system is designed in a VECSEL configuration, also called PUCSEL (Philips Upconversion Surface Emitting Laser). The first end mirror is formed of a DBR (Distributed Bragg Reflector) 16, which is attached to the active layer 17 as the gain medium for the pump laser. On the right hand side of the active layer 17 a partial DBR 18 is arranged which partially reflects the fundamental infrared radiation (preferably T=5-20%) in order to lower the lasing threshold of the pump laser. A thermal lens or an integrated lens 20 serves for generation of the beam waist 13 inside of the upconverting material 8. Electrical contacts 19 are used for electrical pumping of the semiconductor pump laser. These components are arranged on a heat sink 15 for heat removal during operation. The upconversion laser cavity 10 is formed in the same manner as already described in connection with FIG. 2. The two DBR layers 16, 18 of the pump laser are used to tailor the wavelength of operation of the infrared laser, so that the external cavity mirror can be a very simple element.

The upconverting material 8 should be made in such a way that the intracavity power is reduced by 1 to 10% due to absorption in the upconverting material. The absorption properties of the upconverting material can be tailored by the dopant concentration and the length of the medium. This consideration should be explained with the example of 3000 ppm Er³⁺-doped ZBLAN as the upconverting material. This material has an absorption coefficient of about α=0.12 cm⁻¹ at a wavelength of around 970 nm. The absorption through a material of length x and absorption coefficient α is described by the following equation:

I(x)=I₀e^{-αx}

The material should have a length L. A roundtrip of the pump radiation through the material then corresponds to an absorption path of 2L. The fraction k of the absorbed pump power should be the roundtrip loss from the pump laser cavity. Therefore the power fed back to the pump laser cavity reads as:

I(2L)=(1−k)I₀

Finally the length L(k) of the upconverting material as a function of the absorption k can be calculated according to:

$$L ( k ) = - \frac{ln ( 1 - k )}{2 α}$$

This curve is plotted in FIG. 4 showing the length L of the upconverting material for various fractions of absorbed pump power k. A length of L=2 mm leads to an absorption of k≈5% of the pump power in the upconverting material. It is evident that the length of the upconversion material can be in the order of a few mm as compared to the typical 50 cm length of upconversion fiber lasers. This is a drastic size reduction even without any changes in the doping concentration of the Er-doped ZBLAN upconverting material.
1 laser diode bar
2 cooling structure
3 upconversion laser
4 gain medium for diode laser
5 first mirror
6 second mirror
7 pump laser cavity
8 upconverting material
9 third mirror
10 upconversion laser cavity
11 anti reflecting coating
12 lens
13 beam waist
14 visible output
15 heat sink
16 DBR
17 active layer
18 partial DBR
19 electrical contacts
20 integrated lens

1. Upconversion laser system comprising at least a semiconductor laser having a gain structure (4, 17) arranged between a first mirror (5, 16) and a second mirror (6), said first (5, 16) and said second mirror (6) forming a laser cavity (7) of the semiconductor laser, and an upconversion laser for upconverting a fundamental radiation of said semiconductor laser,
characterized in that said upconversion laser is arranged in the laser cavity (7) of the semiconductor laser.

2. Upconversion laser system according to claim 1,
characterized in that said upconversion laser comprises an upconverting solid state medium (8) between two mirrors (6, 9), one of said mirrors being highly reflective and the other being partially transmissive for upconverted radiation.

3. Upconversion laser system according to claim 2,
characterized in that one of said mirrors (6, 9) of the upconversion laser is the second mirror (6) of said semiconductor laser.

4. Upconversion laser system according to claim 2,
characterized in that said mirrors (6, 9) of said upconversion laser are formed of dielectric coatings on said upconverting solid state medium (8).

5. Upconversion laser system according to claim 1,
characterized in that the semiconductor laser comprises an optical system (12) generating a beam waist (13) of the fundamental radiation within the upconverting solid state medium (8).

6. Upconversion laser system according to claim 1,
characterized in that the semiconductor laser is designed in a VECSEL configuration.

7. Upconversion laser system according to claim 6,
characterized in that said first mirror (5, 16) is formed as a DBR-structure (16) on said gain structure (4, 17).

8. Upconversion laser system according to claim 1,
characterized in that said semiconductor laser is designed to generate IR radiation.

9. Upconversion laser system according to claim 2,
characterized in that the upconverting solid state medium (8) is made of Er:ZBLAN.

10. Upconversion laser system according to claim 1,
characterized in that several of said semiconductor lasers are arranged to form an array of laser sources.

11. Upconversion laser system according to claim 1 in a projection system or in a fiberoptic illumination unit.
